(19) United States
(12) Patent Application Publication
(10) Pub. No.: US 2004/0121835 A1
(43) Pub. Date: Jun. 24, 2004

(54) System and method for a gaming console offering multiple services

(76) Inventors: Daniel Willis, Stittsville (CA); Dhananjay Godse, Kanata (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/324,021

(22) Filed: Dec. 20, 2002

(51) Int. Cl. A63F 13/00

(52) U.S. Cl. 463/20

(57) ABSTRACT

An interactive gaming system for allowing for multiple user definitions is disclosed. Multiple user definitions for example enable multiple personalities and multiple services to be associated with one gaming console. The interactive gaming system has customer located equipment and a gaming service provider, the customer located equipment being connected to the gaming service provider through a broadband access network, and including at least one gaming console. The gaming console comprises a flat memory space for storing gaming software, a restricted kernel for running the gaming software on the gaming console, and for making hardware of the gaming console accessible to the gaming software, and a memory in contact with the restricted kernel for storing a gaming client on the gaming console. The gaming client establishes a connection between the gaming console and the service provider, and wherein the gaming client establishes one out of a plurality of possible multiple user services.

### FIELD OF THE INVENTION

The present invention generally relates to interactive gaming systems, and more specifically to on-line gaming systems wherein a gaming console connected to service providers enables more than one service simultaneously.

### BACKGROUND OF THE INVENTION

Since its origins, dating back to the early seventies of the last century, computer gaming did not only undergo a period of substantial growth, but also dramatically changed its role in social interactions and interpersonal relationships. In our modern world, the computer gamer is no longer an isolated and introverted individual, but is part of a rich and active community of like-minded people. In recent times, the ongoing developments in the field of computer gaming led to the creation of new and exciting markets, as for example on-line computer gaming. The rapid expansion of the Internet network, which by now has achieved the status of an almost omnipresent medium, provides not only the basis, but also the boost for the constant developments in on-line computer gaming.

During the last couple of years, on-line computer gaming has gained increasing popularity, and today thousands of players are playing on-line all around the world. Many people stereotype this group as techno kids only, but this could not be more wrong. Both females and males of all ages can be found daily trying to out-think, out-maneuver, or just having a good time on-line. On the Eve of the Electronic Entertainment Expo (E3Expo), the world's largest trade event showcasing computer and video games and related products, a new survey by Peter D. Hart Research Associates, Inc., has found that three-in-five Americans age six or older, or about 145 million people, say they routinely play computer or video games, and that nearly half of these game players are female. Predictably, interactive on-line computer gaming will blur the line between games and other entertainment or communication media, and the avenues explored in the development of on-line gaming might well break new ground for interactive Internet applications in all areas of business relations and social life.

One of the essentials for the participant in on-line gaming is the appropriate gaming hardware, like a suitable gaming console, a proper network connection, and other peripheral devices. As a general case, however, gaming consoles are constructed as to support one single on-line service at a time only. It is often not possible for different members of a common household to share the same gaming console connected to one particular gaming service provider. Also, in many cases a gaming console is associated with specific customer attributes, which makes it difficult or nearly impossible for more than one user to share a same gaming console, and yet utilize the full potential of a personalized gaming interface to the realm of on-line gaming experiences.

It would be advantageous to provide a gaming system that allows different services to be executed with a given gaming console at the same time. The gaming console then would support a multiple session environment, in which different users could utilize different services offered by the gaming console at the same time. The services are not restricted to on-line gaming per se, but include for example audio services or other suitable background tasks. It would be further advantageous to provide a gaming system, in which a gaming console connected to a given gaming service provider supports a multiple personalities structure.

### OBJECT OF THE INVENTION

It is therefore an object of the instant invention to provide a gaming system in which one single gaming console is configured to for multiple concurrent services applications.

It is further an object of the instant invention to provide a gaming system in which one single gaming console is configured to support multiple user personalities.

### SUMMARY OF THE INVENTION

According to an aspect of the instant invention, there is provided an interactive gaming system having customer located equipment and a gaming service provider, the customer located equipment being connected to the gaming service provider through a broadband access network, and including at least one gaming console. The gaming console comprises a flat memory space for storing gaming software, a restricted kernel for running the gaming software on the gaming console, and for making hardware of the gaming console accessible to the gaming software, and a memory in contact with the restricted kernel for storing a gaming client on the gaming console. The gaming client establishes a connection between the gaming console and the service provider, and wherein the gaming client establishes one out of a plurality of possible multiple user services.

According to another aspect of the instant invention there is provided a method for providing an interactive gaming system service. The method comprises a step of connecting customer located equipment and a gaming service provider through a broadband access network. The customer located equipment includes at least one gaming console, and the gaming console comprises a flat memory space for storing gaming software, a restricted kernel for running the gaming software on the gaming console, and for making hardware of the gaming console accessible to the gaming software, and non-volatile random access memory in contact with the restricted kernel. The method further comprises the steps of storing an gaming client in memory, establishing a connection between the gaming console and the service provider through the gaming client, controlling events taking place on the gaming console according to messages sent to and received from the gaming service provider; and establishing multiple user services on the gaming console.

### BRIEF DESCRIPTION OF THE DRAWINGS

An exemplary embodiment of the present invention will be described in conjunction with the following drawings, in which similar reference numbers designate similar items:

FIG. 1 displays a schematic diagram of an on-line gaming architecture;

FIG. 2 displays a schematic diagram of an on-line gaming software architecture;

FIG. 3a displays a schematic diagram of a gaming console having a restricted kernel and a flat memory space;

FIG. 3b displays a schematic diagram of a gaming console having a restricted kernel, a flat memory space; and a highly functional client incorporated into the flat memory space;

FIG. 3c displays a schematic diagram of a gaming console having a restricted kernel, a flat memory space; and a highly functional client incorporated into the restricted kernel;

FIG. 3d displays a schematic diagram of a gaming console having a restricted kernel, a flat memory space; and a highly functional client residing in non-volatile random access memory; and

FIG. 4 displays a schematic block diagram illustrating a multiple user system.

### DETAILED DESCRIPTION OF THE INVENTION

The present invention is now described with respect to a specific embodiment thereof, in which a gaming link architecture is used to provide an interactive gaming system service, and in which a customer gaming console is integrated into the gaming link architecture. Of course, the invention described herein is not restricted to a particular example, which will be described in what follows, but equally applies to other architectures possibly used to establish and provide an on-line gaming scenario.

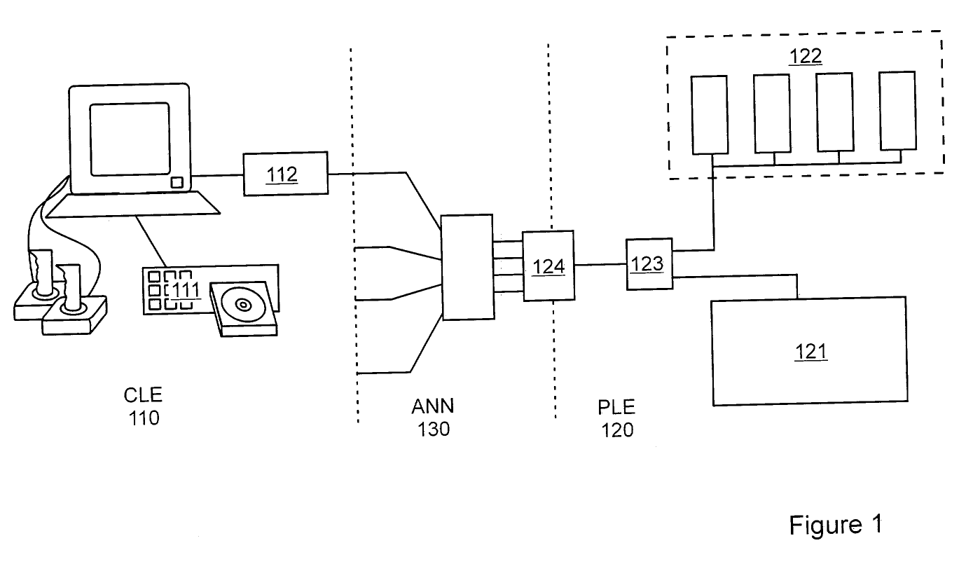

Referring to FIG. 1, a schematic diagram of the gaming link architecture G_linkA for providing an on-line gaming environment is presented. The main components of G_linkA are a customer site containing customer located equipment CLE 110, a gaming provider site containing provider located equipment PLE 120, and an access aggregation network AAN 130 connecting CLE 110 with PLE 120. The customer located equipment CLE 110 includes a gaming console (GC) 111 and other hardware components necessary for playing a game, such as a monitor, joysticks, and the like, and a modem 112 for establishing the connection to the AAN 130. The modem 112 is for example a broadband access modem, a cable modem, a satellite modem, or any other type of modem. Optionally, other peripheral devices such as a compact disc for storing gaming software and gaming data are connected to the gaming console (GC) 111. On the PLE site 120 there is located a gaming service provider network GSP 121, a management network 122 utilizing an access provider operations support systems AP-OSS, a router 123 and a head-end 124, establishing the connection to the ANN 130, among other components. The access aggregation network ANN 130 generally is a wide area network WAN, and preferably a broadband access network BAN.

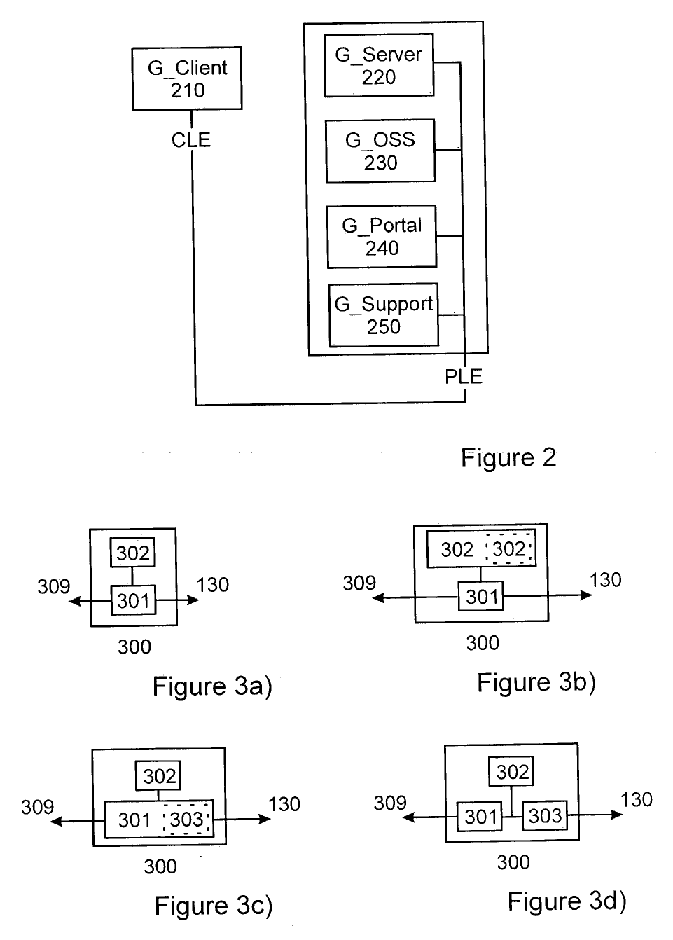

Referring now to FIG. 2, a schematic diagram is shown, illustrating the basic elements of the software architecture used in providing an on-line gaming environment. On the CLE site, the main component is a gaming client G_client 210, whereas on the PLE site there is a gaming server G_server 220, an operations support systems engine G_OSS 230, a gaming portal G_portal 240, and support services G_support 250.

Although the set up of the gaming client G_client 210 is at the essence of the instant invention, the software elements on the PLE site of the gaming architecture are equally important to practice the instant invention. Therefore, the elements on the PLE site according to one specific embodiment of the instant invention are now described in more detail. A person of skill in the art easily envisions other architectures for the PLE site.

The purpose of the gaming server G_server 220 is to provide the connectivity and registration services for gaming consoles (GC), and to manage the registered devices. Typically, G_server 220 deals with console discovery, client registration, subscriber authentication, console address management, as well as Internet protocol (IP) connectivity management and proxy for gaming consoles (GC). G_server 220 also manages the different GC and different subscribers being part of the on-line gaming architecture G_linkA. Further, G_server 220 deals with connection qualification services for consoles, and with bundled instrumentation, and reports facilities for instrumentation, performance and management of G_client 210.

Another purpose of G_Server 220 is to perform additional tasks, and to provide managing, monitoring, and debugging facilities for the gaming link architecture. G_Server 220 performs tasks of checking network connections, and of controlling accessibility of relevant hardware components, as well as software modules. Debugging is preferably performed by sending out well-defined test messages, and by running well-defined test applications. Optionally, G_Server 220 performs the additional tasks in cooperation with other servers, as for example G_support 250 and G_OSS 230.

The purpose of the operation support systems engine G_OSS 230 is to provide an application program interface (API) to tie-in with the network service provider's software engines for subscriber authentication, notification, and billing functionalities. G_OSS 230 supports multi-protocol API, containing common utilities with plug-in adapters to facilitate connectivity to a majority of other operation support systems (OSS), the plug-in adaptation cartridges supporting Hyper Text Transfer Protocol (http), Simple Network Management Protocol (SNMP), eXtensible Markup Language (XML), JAVA™ and the like. Also, G_OSS 230 adds, modifies, or deletes a GC or a subscriber to the on-line gaming service, and takes care of billing and service notification, among other related functionalities.

The purpose of the gaming portal G_portal 240 is to provide a site for net-based gaming services. It also acts as a proxy site through which net-based game content providers offer content and services to the user of the gaming console GC. G_portal 240 provides an entry point into the on-line gaming network for game specific servers, for connection servers enabling group gaming, head-to-head services and find-a-friend scheduling, for bulletin boards and chat rooms, as well as for gaming sites and news proxy. Also, G_portal 240 provides the possibility to tie in the gaming link architecture to make services offered by other providers accessible to a user of the gaming console, such as for example services provided by the hospitality industry.

Optionally, G_portal 240 offers possibilities such as pay-per-play services, advertising, download services, and others. Although designed as an on-line gaming environment, G_portal 240 enables one to extend the uses of a plurality of gaming consoles (GC) interconnected through a broadband access network beyond gaming and entertainment.

The system of support services G_support 250 fulfills functions such as running a dynamic host configuration protocol (DHCP), Web servicing, platform and application management, subscriber management, license servicing, and the like. Within the system of support services, there is a dynamic host configuration protocol server G_DHCP, a Web server G_Web dealing with GSP content, GSP data, and GSP instrumentation, as well as a registration server G_Reg.

After the description of the components associated with the PLE site, the components of the CLE will now be discussed in more detail. The purpose of the gaming client G_client 210 is to provide the gaming console with services, such as establishing connectivity and registration. G_client 210 comprises a registration client, an authentication client, a console address management module, and a module for enabling connectivity and service to a gaming service provider GSP 121 on the PLE site 120. G_client 210 supports established methods for data communication and transfer.

There exist different solutions to the problem of choosing an ideal G_client 210 for a gaming environment. Typically, gaming consoles (GC) have a limited, flat memory space. On the other hand, a highly functional client is required, to be co-resident with the primary application in the gaming console (GC), the primary application typically being an on-line computer game.

Referring to FIG. 3a, a schematic diagram of the architecture of a GC 300 is shown. The gaming console comprises a restricted kernel 301 and a flat memory space 302. The restricted kernel is in connection with the gaming console hardware 309, as well as with the flat memory space 302. Optionally, when the gaming console is used for on-line gaming, the restricted kernel 301 is in connection with the access aggregation network 130. The flat memory space typically comprises one single software application, namely a video game, or other gaming software. In order to install a highly functional client 303 on the GC, the client 303 is optionally integrated into the gaming software, and loaded together with the gaming software into the flat memory space 302. This solution is illustrated in the schematic diagram shown in FIG. 3b. However, in this set-up, changes in client modification require changes in the gaming software package. Another solution is to integrate the highly functional client 303 into the restricted kernel 301. This solution is illustrated in the schematic diagram shown in FIG. 3c. However, in this set-up two competing applications are run in the restricted kernel 301, namely the gaming software and the highly functional client 303. This most likely has a negative effect on the gaming performance of the GC. A third solution, especially useful in connection with a broadband access network, is to dedicate a small random access memory (RAM) to the highly functional client 303, thus leveraging a high bandwidth connection to the gaming console, and using it to care and feed a highly functional client 303. This solution is illustrated in the schematic diagram shown in FIG. 3d. In case of a gaming console (GC), the highly functional client is a gaming client. Typically, the highly functional client 303 is an ultra-thin client UTC. The UTC is initially loaded from an external source into the dedicated random access memory. The external source is for example a peripheral storage device connected to the gaming console, such as a memory cartridge or a compact disc. Alternatively, the UTC is provided through the network from the gaming service providers. Other possibilities in providing an UTC are not excluded from embodiments of the instant invention. As an advantage of this architecture, the gaming client G_client 210 becomes very scalable and flexible, and is growing outside the GC without impacting the footprint occupied within the GC. Also, client code portability between different gaming platforms is highly simplified. This way, G_client 210 provides an adaptive platform for a consistent gaming environment

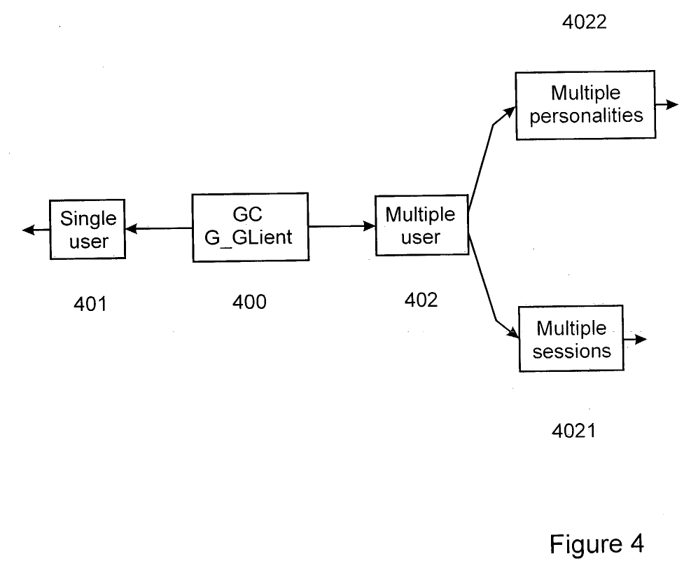

Referring now to FIG. 4, possible application hierarchies for a gaming console comprising G_client 400 are illustrated. In single user mode 401, the gaming console comprising G_client 400 is reserved for and dedicated to one single user. The tasks executed in the restricted kernel are single applications, supported by the ultra-thin client. In multiple user mode 402 the gaming console comprising G_client 400 supports multiple user applications. Multiple sessions are executed on the gaming console by the restricted kernel within the flat memory space. The ultra thin client (UTC) performs tasks according to shared resources and shared memory strategies. These strategies include for example cycle stealing for a most effective use of unused resources on the gaming console comprising G_client 400, as well as a task priority assessment.

Among other possibilities, the multiple user approach includes multiple sessions 4021 as well as multiple personalities 4022. In multiple sessions 4021, for example, a first session is dedicated to downloading and initializing gaming software, whereas a second session is dedicated to playing audio data. The audio data are for example received from a peripheral compact disc, or they are received over the AAN 130 as MPEG data. The UTC handles both processes simultaneously. The first session is preferably associated with a peripheral video device, whereas the second session is associated with a peripheral audio device. This way, both sessions are realized within one gaming console comprising G_client 400 at a same time. The task priority assessment executed by the UTC is done in a way that a stream of audio data as continuous as is received, which possibly involves the use of memory buffers and related strategies.

According to a multiple personalities 4022 approach, a same gaming console supports different user personalities. User personalities are optionally associated with personal user profiles (PP). The personal user profiles are for example stored with non-volatile random access memory incorporated in the gaming console, or they are stored with a gaming service provider a user is subscribing to. The personal profile preferably contains information related to gaming preferences, like genre of a game and characteristics of a game, as well as information related to the user, like gaming pseudonym, and optionally age and gender. When for example a father wants to play educational on-line games together with his children, he might choose to register to the gaming service provider according to his Fantastic Father profile, in which a special set of gaming attributes is stored. These gaming attributes for example specify that only non-violent games with a content suitable for a general audience are to be made available to the registered gaming console. Other players connected to the on-line gaming subscriber see the gamer Fantastic Father associated with his gaming preferences. Fantastic Father is then likely excluded from the list of possible gaming partners wanted for on-line gaming activities set in Stalingrad of January 1943. On the other hand, when the father wants to play on-line games more suitable to his mature recreational needs, he might want to choose to register to the gaming service provider according to his Father Fantastixxx profile.

Of course, a gaming console supporting multiple user services possibly supports both multiple sessions as well as multiple personalities. Optionally, multiple sessions and multiple personalities are supported at the same time. Further optionally, the UTC assesses priorities to different services such that a given service becomes an inactive background service whereas another service becomes an active foreground service. The inactive background service is assigned only a minimum number of computing cycles to sustain the process, whereas the foreground service is given as many cycles as possible in order to sustain continuous processing. Possibly, the users of the gaming console comprising G_client 400 switch priorities of different services associated with a gaming console comprising G_client 400.

Although the instant invention has been described with respect to specific embodiments thereof, various changes and modifications are optionally carried out by those skilled in the art without departing from the scope of the invention. Therefore, it is intended that the instant invention encompass such changes and modifications as fall within the scope of the appended claims.

What is claimed is:

1. An interactive gaming system having customer located equipment and a gaming service provider, the customer located equipment being connected to the gaming service provider through a broadband access network, the customer located equipment including at least one gaming console, the gaming console comprising:
a flat memory space for storing gaming software;
a restricted kernel for running the gaming software on the gaming console, and for making hardware of the gaming console accessible to the gaming software; and
a memory in contact with the restricted kernel for storing a gaming client on the gaming console;
wherein the gaming client establishes a connection between the gaming console and the service provider, and wherein the gaming client establishes one out of a plurality of possible multiple user services.

2. An interactive gaming system according to claim 1, wherein the gaming client is an ultra-thin client.

3. An interactive gaming system according to claim 1, wherein the multiple user services are multiple personalities services.

4. An interactive gaming system according to claim 3, wherein the multiple user personalities services are associated with personal profiles.

5. An interactive gaming system according to claim 1, wherein the multiple user services are associated with multiple sessions.

6. An interactive gaming system according to claim 5, wherein the multiple sessions comprise a plurality of sessions, and wherein different sessions are associated with different peripheral devices of the gaming console.

7. An interactive gaming system according to claim 1, wherein the multiple user services comprise services related to on-line gaming.

8. An interactive gaming system according to claim 1, wherein the multiple user services comprise services other than related to on-line gaming.

9. An interactive gaming system according to claim 1, wherein the gaming client filters a gaming request received from the gaming console according to at least one predefined criterion.

10. An interactive gaming system according to claim 9, wherein a gaming request received from the gaming console is filtered according to a personal profile provided by a subscriber to the interactive gaming system.

11. An interactive gaming system according to claim 10, wherein a gaming request received from the gaming console is filtered in accordance with the personal profile according to a content of the game requested.

12. An interactive gaming system according to claim 1, wherein the multiple user services comprise a plurality of services, each service out of the plurality of services being associated with a different processing priority.

13. An interactive gaming system according to claim 1, wherein the multiple user services comprise a plurality of services, each service out of the plurality of services being associated with different resource consumption characteristics.

14. A method for providing an interactive gaming system service, the method comprising the steps of:
connecting customer located equipment and a gaming service provider through a broadband access network, the customer located equipment including at least one gaming console, the gaming console comprising a flat memory space for storing gaming software, a restricted kernel for running the gaming software on the gaming console, and for making hardware of the gaming console accessible to the gaming software, and non-volatile random access memory in contact with the restricted kernel.
storing a gaming client in memory;
establishing a connection between the gaming console and the service provider through the gaming client;
controlling events taking place on the gaming console according to messages sent to and received from the gaming service provider; and
establishing multiple user services on the gaming console.

15. A method for providing an interactive gaming system service according to claim 14, wherein the gaming client is an ultra-thin client.

16. A method for providing an interactive gaming system service according to claim 14, wherein the step of establishing multiple user services comprises the step of establishing multiple personalities services.

17. A method for providing an interactive gaming system service according to claim 16, wherein the step of establishing multiple user personalities services comprises the step of making associations with personal profiles.

18. A method for providing an interactive gaming system service according to claim 14, wherein the step of establishing multiple user services comprises the step of establishing multiple sessions.

19. A method for providing an interactive gaming system service according to claim 18, wherein the multiple sessions comprise a plurality of sessions, and wherein different sessions are associated with different peripheral devices of the gaming console

20. A method for providing an interactive gaming system service according to claim 14, wherein the multiple user services comprise services related to on-line gaming.

21. A method for providing an interactive gaming system service according to claim 14, wherein the multiple user services comprise services other than related to on-line gaming.

22. A method for providing an interactive gaming system service according to claim 14, further comprising the step of filtering a gaming request received from the gaming console according to at least one predefined criterion.

23. A method for providing an interactive gaming system service according to claim 16, wherein a gaming request received from the gaming console is filtered according to a personal profile provided by a subscriber to the interactive gaming system.
